(19) United States
(12) Patent Application Publication
(10) Pub. No.: US 2006/0259511 A1
(43) Pub. Date: Nov. 16, 2006

(54) Media object organization across information management services

(75) Inventors: Marco Boerries, Los Altos Hills, CA (US); Joseph Joaquin Martin, San Francisco, CA (US); Torsten Schulz, Pinneberg (DE); Jerald Jayant Singh, Sunnyvale, CA (US); Venkatachary Srinivasan, Sunnyvale, CA (US)

Correspondence Address: MORRISON & FOERSTER LLP, 425 MARKET STREET, SAN FRANCISCO, CA, 94105-2482, US

(73) Assignee: Yahoo! Inc., Sunnyvale, CA (US)

(21) Appl. No.: 11/129,697

(22) Filed: May 13, 2005

(51) Int. Cl. G06F 17/00

(52) U.S. Cl. 707/103 R

(57) ABSTRACT

A media object organizer organizes media objects, such as still or moving photographic images, audio files, or documents. The media object organizer includes memory for storing metadata concerning media objects, and association logic for associating at least one metadatum with at least one organizational attribute maintained by an information management service. The information management service may be a PIM-type service, such as calendar, address book or task list. The organizational attribute may be based upon time, place or person, among other attributes.

### BACKGROUND OF THE INVENTION

1. Field of the Invention

The present invention generally relates to the organization and display of media objects, and, more particularly, to dynamically grouping media objects according to organizational attributes of information management services, such as those found in personal information management devices (PIMs).

2. Description of the Related Art

Users of media recording and playback devices are able to store in their personal libraries large volumes of media objects, such as photographic images from digital cameras, and songs from the Internet. While this capability has been widely used, the quantity of information to be managed has become unwieldy. Digital cameras, for example, usually label images with non-descriptive terms. Users of digital cameras thus often need to manually label the images, and organize them into albums based on subject matter. It would be desirable to find a way to automatically label and organize media objects into collections based upon naturally occurring relationships between the media objects and related attributes.

### SUMMARY OF THE INVENTION

The present invention provides a media object organizer for organizing media objects, such as still or moving photographic images, audio files or documents. The media object organizer includes memory for storing one or more metadata concerning a media object, and association logic for associating the metadata with at least one organizational attribute maintained by an information management service. The information management service may be a service such as calendar, address book or task list. The media object organizer may extract the metadata from information from an apparatus providing the media object.

The organizational attribute may be based upon an event or upon time, such as the date the media object is created. For time-based or event-based attributes, the information management service may comprise a calendar. Alternatively, the organizational attribute may be based upon place, in which case the information management service may comprise an address book or a calendar. The association logic may chronologically order media objects related to the same place. As another alternative, the organizational attribute may be based upon a person, in which case the information management service may comprise an address book or a calendar. In yet another alternative, the organizational attribute may be based upon an identification of a calling number from a telephone, in which case the information management service may comprise an address book.

The apparatus may be a device, such as a digital camera, an audio playback device or a GPS unit, or a server, such as an email server or a media server. For an email server, the organizational attribute may be based upon a sender of email, and the information management service may comprise an address book.

The association logic, which may be implemented as a rules evaluator, may group together into a collection media objects associated with the same organizational attribute. The association logic may provide a set of organizational attributes associated with the one or more metadata, from which set a user may select an organizational attribute to be associated with a collection of media objects. Display logic may present to a user a collection of media objects associated with the same organizational attribute.

The media object organizer may associate an annotation with the media object for presentation together to the user, wherein the annotation comprises an associated organizational attribute or one or more metadata related to the media object. The media object organizer may provide a set of optional annotations from which a user may select an annotation to be presented together with the media object. The association logic may group together into a collection media objects associated with the same organizational attribute, wherein the annotation associated with at least one media object in the collection may be different from the organizational attribute associated with the collection.

### BRIEF DESCRIPTION OF THE DRAWINGS

FIG. 1 illustrates a media object organizer according to embodiments of the present invention.

FIG. 2 illustrates a media object record including metadata and a reference to a media object according to embodiments of the present invention.

FIG. 3 illustrates an example of a calendar entry according to embodiments of the present invention

FIG. 4 illustrates a display of an album of thumbnail images according to embodiments of the present invention

### DETAILED DESCRIPTION OF THE INVENTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

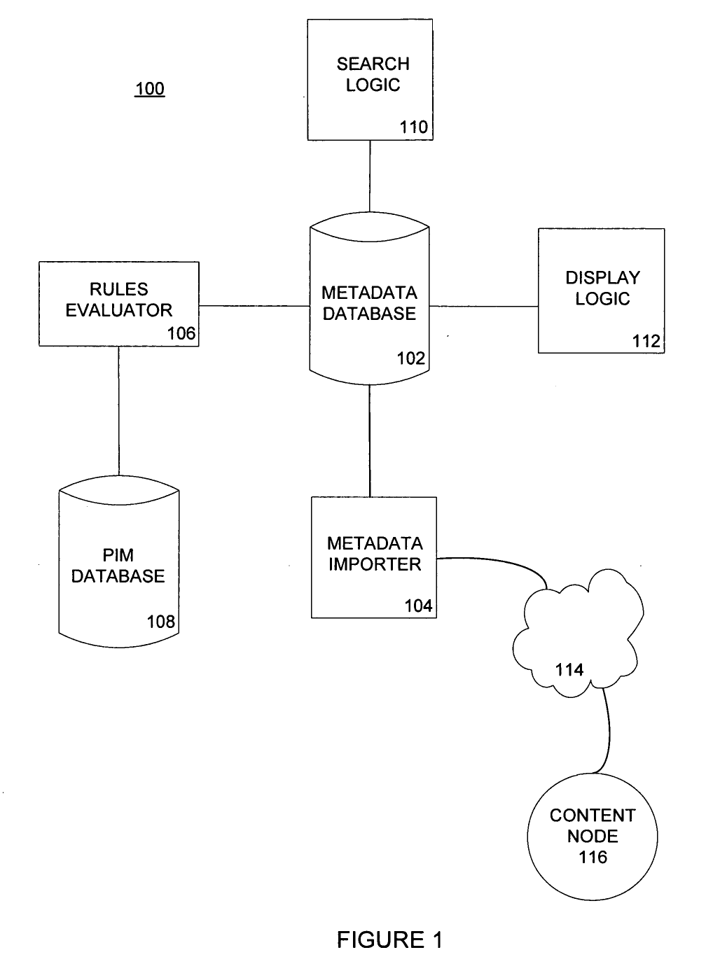

FIG. 1 illustrates a media object organizer 100 according to embodiments of the invention. The media organizer may include memory such as a media object metadata database 102, a metadata importer 104, a rules evaluator 106, memory such as an information management services database 108, search logic 110, and display logic 112. Those skilled in the art will recognize that the information management services and metadata databases may reside in the same database.

The media object organizer 100 may be stored as an application in any computer system. For example, the media object organizer may run on a standalone computer or on a client computer connected to a media server over a network. The discussion below describes a media object organizer for photographic images, as an example. Those skilled in the art will recognize that the media object organizer may be used to organize collections of any type of media object, such as still images, moving images, audio files and documents. The images may be either derived from a photograph or computer-generated.

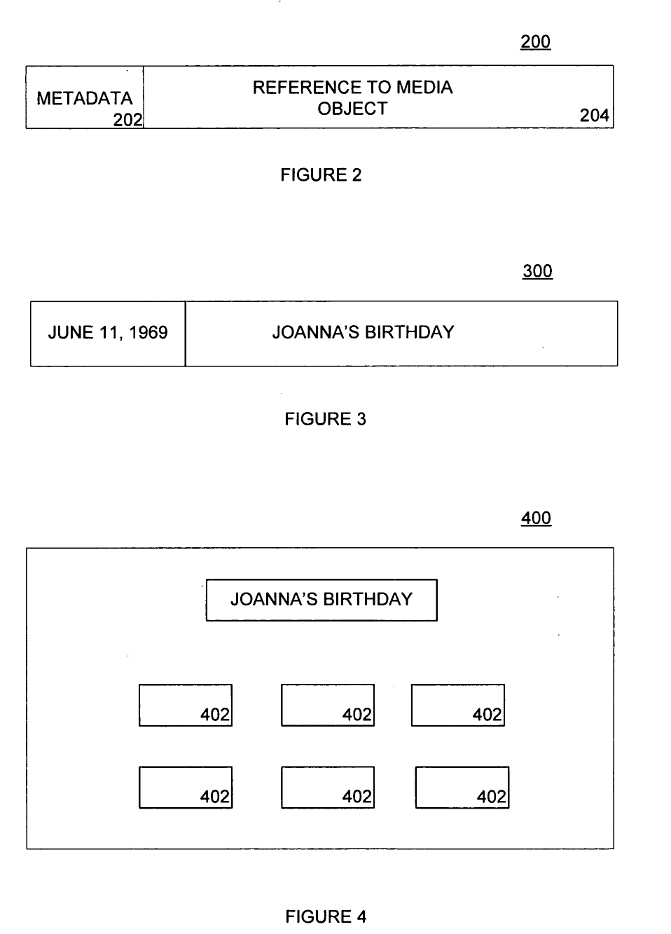

The metadata importer 104 loads metadata related to media objects into the media object metadata database 102. FIG. 2 illustrates a metadata record 200 including metadata 202 and a reference 204 to the storage location of a media object. The metadata may include a record identifier uniquely identifying the media object. The metadata importer 104 may extract metadata from a local computer memory storing the media objects and associated metadata, which in turn obtained the metadata from one or more content-providing apparatus providing the metadata. The apparatus may be a device connected directly to the local computer, such as a digital camera or an audio playback device, from which the media objects and metadata are loaded into the local computer memory. Alternatively, the metadata importer 104 may extract the metadata from information from an apparatus that is a node on a network 114 that provides content (i.e., content node 116), such as a media server like Yahoo! Photos®. The metadata importer 104 may retrieve (pull) the metadata from the apparatus, or the apparatus may push new metadata to the metadata importer upon receipt of a new media object. Those skilled in the art will recognize that the metadata database 102 may store metadata from multiple apparatus at the same time.

For example, the metadata for a photograph may include the date and time the photo was created, aperture, shutter speed and other settings. The metadata importer 104 may extract metadata from, for example, the EXIF (Exchangeable Image File) header stored inside the uploaded file by many digital cameras, or the IPTC (International Press Telecommunications Council) header stored inside the uploaded file by many photo management and organization software packages. The metadata importer 104 may also note the date and time the media object was uploaded, and store that information as metadata in the metadata database 102, as well.

The metadata importer 104 may extract metadata from information provided by other devices, such as a video camera, or an audio playback device. Alternatively, the apparatus providing metadata may comprise a media server, such as a photo server or a music server, or an email server. The media server may, in turn, receive media objects and metadata uploaded from devices such as a camera phone. From an email from the email server, the metadata importer 104 may extract the sender identifier as a metadatum. A mobile device such as a video camera or camera phone may include a GPS unit to provide geographic coordinates. In that case, the metadata importer may extract location metadata from information provided by the GPS unit, either directly from the GPS unit connected to the local computer or over a network from a server storing the media object associated with the GPS unit.

The information management services database 108 stores organizational attributes provided by information management devices. An information management device is any device that organizes information, including PIM devices such as a Blackberry® or a Treo®, or more dedicated mobile phones that provide more limited information management services. Information management services may include, for example, PIM services such as calendar, address book, tasks, and notes. A calendar typically maintains time-related organizational attributes such as events (e.g., meetings, birthdays, holidays) related to corresponding date and time ranges. Referring to FIG. 3, for example, a calendar may maintain an entry 300 for “Joanna's Birthday” for Jun. 11, 1969. An address book typically maintains organizational attributes related to a person (e.g., a legal “person” such as a human or business entity, or even a pet), a place (e.g., the person's address), or other contact information attributes (e.g., telephone numbers). The information management services database 108 receives these organizational attributes from the information management devices, frequently upon (wired or wireless) connection of the information management device to the media object organizer 100.

The rules evaluator 106 may associate each received metadatum with an organizational attribute or a set of related organizational attributes (e.g., the set of the same birthday month and day over a period of years) maintained by an information management service. For example, the rules evaluator may associate a date metadatum associated with a photograph uploaded from a digital camera with an event such as a birthday or vacation scheduled on that date in a calendar. In other examples, the rules evaluator 106 may associate sender metadatum from an email with a person in an address book, or associate a location metadatum from a GPS unit with an address in an address book, and thus with the person located at that address. In another example, the rules evaluator may associate caller ID (i.e., ANI) metadatum from a mobile phone with a telephone number in an address book, and thus with the person assigned that telephone number. As a result, a photo image sent from a camera phone may be associated with the person sending the photo based upon the ANI.

The association of metadata with organizational attributes enables the media objects to be grouped into one or more dynamic collections according to common organizational attributes. The organizational attribute for a collection may be derived from many different information management services, or just those specified by the user. Similarly, the metadata and associated media objects for a collection may be derived from many different apparatus, or just those specified by the user.

The metadata database 102 or other memory may store the associations of organizational attributes with media object record identifiers, thereby storing the information necessary to identify the collections. The collections are “dynamic” in that the addition of a media object to a user's library of media objects requires the rules evaluator to determine an association for the new media object, which may result in the media object being added to an existing collection.

The collections may be, for example, dynamic electronic photo albums or music playlists. The media objects need only be stored in one place, e.g., file storage on a user's computer or on a media object server, with the database 102 providing a reference storage location for each media object. Because each media object may belong to more than one collection, the use of references eliminates the need for redundant storage.

The search engine 110 allows a user to search for media objects based upon organizational attribute, e.g., an event such as a birthday party (e.g., based upon the date the media object was created), a location such as a friend's home, or a person. Display logic 112 allows the set of media objects associated with the same organizational attribute to be presented to a user. The display logic 112 may use any format commonly used for images or other media objects, such as lists or thumbnails that are enlargeable based on user clicking of the thumbnail. FIG. 4 illustrates the example of a display of an album 400 of photo images in thumbnail form for the organizational attribute Joanna's Birthday. Each image 402 may be identified in the database 102 by a different record identifier. For any non-time-related organizational attribute (e.g., location), the database search queries allow the media objects to be retrieved organized first by the non-time-related attribute, and then chronologically. For example, the display may show chronologically-ordered photographs relating to the same place.

Rather than automatically creating one or more collections, the rules evaluator 106, through the display logic user interface, may present to a user a set of natural choices for collections. A media object may correspond to different metadata that may be associated with different organizational attributes. For example, a digital camera with a GPS unit may provide an image having time and location metadata that may be associated with both the organizational attributes “Joanna's birthday” from a calendar entry and “Shelley's house” (Shelley hosted Joanna's party) from an address book entry. The user may be given the option to choose one of the organizational attributes (Joanna's birthday or Shelley's house) as the organizing theme for a photo album. In another example, a single metadatum for a media object may match multiple organizational attributes. For example, the location metadatum of the image may correspond not only to Shelley's house, but also to Wendy's house (in the case where Wendy is Shelley's roommate). The user may be given the option to choose either Shelley's house or Wendy's house as the organizational attribute serving as the organizing theme of the album.

Moreover, the rules evaluator 106 may associate an annotation with the media object, wherein the annotation comprises at least one matching organizational attribute or at least one metadatum for the media object. This association allows presentation of the annotated media object (whether alone or as part of a collection) to the user. The rules evaluator may present to the user, through the display logic 112, a list of matching organizational attributes or metadata for each media object. The user may select the organizational attribute or metadatum to use as an annotation.

Note that, even though a media object may be presented to the user as part of a collection collectively labeled according to one organizational attribute or metadatum, each media object within the collection may be individually annotated with the selected annotation (which may differ from the label of the collection). For example, some photographs may be displayed with the label “Joanna's birthday party,” where the label is derived from the calendar entry (organizational attribute) corresponding to the date metadatum indicating the date the photo was taken. However, the user may instead choose to display a collection of photographs associated with the organizational attribute “Hawaii vacation.” If Joanna's birthday took place during a vacation in Hawaii, and the calendar included both the birthday and vacation attributes for the same day, then the displayed album labeled “Hawaii vacation” may include some images individually labeled “Joanna's birthday.”

Based on the foregoing, the media object organizer of the invention allows the automatic organization and labeling of media objects into one or more collections without the need for action by the user.

It will be appreciated that the above description for clarity has described embodiments of the invention with reference to different functional units. However, it will be apparent that any suitable distribution of functionality between different functional units may be used without detracting from the invention. Hence, references to specific functional units are only to be seen as references to suitable means for providing the described functionality rather than indicative of a strict logical or physical structure or organization.

The invention can be implemented in any suitable form including hardware, software, firmware or any combination of these, and, in particular, in program code and associated hardware. Different aspects of the invention may be implemented at least partly as computer software or firmware running on one or more data processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A media object organizer comprising:
memory for storing at least one metadatum concerning a media object; and
association logic for associating the at least one metadatum with at least one organizational attribute maintained by an information management service.

2. The media object organizer of claim 1, wherein the at least one metadatum is extracted from information from an apparatus providing the media object.

3. The media object organizer of claim 1, wherein the association logic is operable to group together into a collection media objects associated with the same organizational attribute.

4. The media object organizer of claim 1, wherein the association logic is operable to provide a set of organizational attributes associated with the at least one metadatum from which set a user may select an organizational attribute to be associated with a collection of media objects.

5. The media object organizer of claim 1, further comprising display logic for presenting to a user a collection of media objects associated with the same organizational attribute.

6. The media object organizer of claim 1, further comprising logic for associating an annotation with the media object for presentation together to the user, wherein the annotation comprises an associated organizational attribute.

7. The media object organizer of claim 1, further comprising logic for associating an annotation with the media object for presentation together to the user, wherein the annotation comprises at least one metadatum related to the media object.

8. The media object organizer of claim 6 or 7, wherein the logic for associating an annotation is operable to provide a set of optional annotations from which a user may select an annotation to be presented together with the media object.

9. The media object organizer of claim 6 or 7, wherein the association logic is operable to group together into a collection media objects associated with the same organizational attribute, wherein the annotation associated with at least one media object in the collection may be different from the organizational attribute associated with the collection.

10. The media object organizer of claim 1, further comprising search logic for searching media objects based upon organizational attribute.

11. The media object organizer of claim 1, wherein the organizational attribute is based upon time.

12. The media object organizer of claim 11, wherein the organizational attribute is based upon the date the media object is created.

13. The media object organizer of claim 11, wherein the information management service comprises a calendar.

14. The media object organizer of claim 1, wherein the organizational attribute is based upon an event.

15. The media object organizer of claim 14, wherein the information management service comprises a calendar.

16. The media object organizer of claim 1, wherein the organizational attribute is based upon a place.

17. The media object organizer of claim 16, wherein the information management service comprises an address book.

18. The media object organizer of claim 16, wherein the association logic is operable to chronologically order media objects related to the same place.

19. The media object organizer of claim 1, wherein the organizational attribute is based upon a person.

20. The media object organizer of claim 19, wherein the information management service comprises an address book.

21. The media object organizer of claim 19, wherein the organizational attribute is based upon an identification of a calling number from a telephone.

22. The media object organizer of claim 2, wherein the apparatus comprises a digital camera.

23. The media object organizer of claim 2, wherein the apparatus comprises an audio device.

24. The media object organizer of claim 2, wherein the apparatus comprises an email server.

25. The media object organizer of claim 22, wherein the organizational attribute is based upon a sender of email, and the information management service comprises an address book.

26. The media object organizer of claim 2, wherein the apparatus comprises a media server.

27. The media object organizer of claim 2, wherein the apparatus comprises a GPS unit.

28. An image organizer comprising:
memory for storing metadata for a plurality of images, including at least one metadatum concerning each image;
association logic for associating the at least one metadatum with at least one organizational attribute maintained by an information management service, wherein the association logic is operable to group together into a collection images associated with the same organizational attribute;
search logic for searching images based upon organizational attribute; and
display logic for presenting to a user a collection of images associated with the same organizational attribute.

29. The image organizer of claim 28, wherein the at least one metadatum is extracted from information from an apparatus providing the image.

30. The image organizer of claim 28, wherein the association logic is operable to provide a set of organizational attributes associated with the at least one metadatum from which set a user may select an organizational attribute to be associated with a collection of images.

31. The image organizer of claim 28, wherein the organizational attribute is based upon time.

32. The image organizer of claim 31, wherein the organizational attribute is based upon the date the image is created.

33. The image organizer of claim 31, wherein the information management service comprises a calendar.

34. The image organizer of claim 28, wherein the organizational attribute is based upon an event.

35. The image organizer of claim 34, wherein the information management service comprises a calendar.

36. The image organizer of claim 28, wherein the organizational attribute is based upon a place.

37. The image organizer of claim 36, wherein the information management service comprises an address book.

38. The image organizer of claim 36, wherein the association logic is operable to chronologically order images related to the same place.

39. The image organizer of claim 28, wherein the organizational attribute is based upon a person.

40. The image organizer of claim 39, wherein the information management service comprises an address book.

41. The image organizer of claim 29, wherein the apparatus comprises a digital camera.

42. The image organizer of claim 29, wherein the apparatus comprises an email server.

43. The image organizer of claim 42, wherein the organizational attribute is based upon a sender of email, and the information management service comprises an address book.

44. The image organizer of claim 29, wherein the apparatus comprises a media server.

45. A method for organizing media objects comprising:
storing at least one metadatum concerning a media object; and
associating the at least one metadatum with at least one organizational attribute maintained by an information management service.

46. The method of claim 45, further comprising extracting the at least one metadatum from information from an apparatus providing the media object.

47. The method of claim 45, further comprising grouping together into a collection media objects associated with the same organizational attribute.

48. The method of claim 45, further comprising providing a set of organizational attributes associated with the at least one metadatum from which set a user may select an organizational attribute to be associated with a collection of media objects.

49. The method of claim 45, further comprising presenting to a user a collection of media objects associated with the same organizational attribute.

50. The method of claim 45, further comprising associating an annotation with the media object for presentation together to the user, wherein the annotation comprises an associated organizational attribute.

51. The method of claim 45, further comprising associating an annotation with the media object for presentation together to the user, wherein the annotation comprises at least one metadatum related to the media object.

52. The method of claim 50 or 51, wherein associating an annotation comprises providing a set of optional annotations from which a user may select an annotation to be presented together with the media object.

53. The method of claim 50 or 51, further comprising grouping together into a collection media objects associated with the same organizational attribute, wherein the annotation associated with at least one media object in the collection may be different from the organizational attribute associated with the collection.

54. The method of claim 45, further comprising searching media objects based upon organizational attribute.

55. The method of claim 45, wherein the organizational attribute is based upon time.

56. The method of claim 55, wherein the organizational attribute is based upon the date the media object is created.

57. The method of claim 55, wherein the information management service comprises a calendar.

58. The method of claim 45, wherein the organizational attribute is based upon an event.

59. The method of claim 58, wherein the information management service comprises a calendar.

60. The method of claim 45, wherein the organizational attribute is based upon a place.

61. The method of claim 60, wherein the information management service comprises an address book.

62. The method of claim 60, further comprising chronologically ordering media objects related to the same place.

63. The method of claim 45, wherein the organizational attribute is based upon a person.

64. The method of claim 63, wherein the information management service comprises an address book.

65. The method of claim 63, wherein the organizational attribute is based upon an identification of a calling number from a telephone.

66. The method of claim 46, wherein the apparatus comprises a digital camera.

67. The method of claim 46, wherein the apparatus comprises an audio device.

68. The method of claim 46, wherein the apparatus comprises an email server.

69. The method of claim 68, wherein the organizational attribute is based upon a sender of email, and the information management service comprises an address book.

70. The method of claim 46, wherein the apparatus comprises a media server.

71. The method of claim 46, wherein the apparatus comprises a GPS unit.

72. A computer program product comprising program code for organizing media objects, the computer program product comprising:
program code for storing in a memory at least one metadatum concerning a media object; and
program code for associating the at least one metadatum with at least one organizational attribute maintained by an information management service.

73. The computer program product of claim 72, further comprising program code for extracting the at least one metadatum from information from an apparatus providing the media object.

74. The computer program product of claim 72, wherein the program code for associating is operable to group together into a collection media objects associated with the same organizational attribute.

75. The computer program product of claim 72, wherein the program code for associating is operable to provide a set of organizational attributes associated with the at least one metadatum from which set a user may select an organizational attribute to be associated with a collection of media objects.

76. The computer program product of claim 72, further program code for presenting to a user a collection of media objects associated with the same organizational attribute.

77. The computer program product of claim 72, further comprising program code for associating an annotation with the media object for presentation together to the user, wherein the annotation comprises an associated organizational attribute.

78. The computer program product of claim 72, further comprising program code for associating an annotation with the media object for presentation together to the user, wherein the annotation comprises at least one metadatum related to the media object.

79. The computer program product of claim 77 or 78, wherein the program code for associating an annotation is operable to provide a set of optional annotations from which a user may select an annotation to be presented together with the media object.

80. The computer program product of claim 77 or 78, wherein the program code for associating is operable to group together into a collection media objects associated with the same organizational attribute, wherein the annotation associated with at least one media object in the collection may be different from the organizational attribute associated with the collection.

81. The computer program product of claim 72, further comprising program code for searching media objects based upon organizational attribute.

82. The computer program product of claim 72, wherein the organizational attribute is based upon time.

83. The computer program product of claim 82, wherein the organizational attribute is based upon the date the media object is created.

84. The computer program product of claim 82, wherein the information management service comprises a calendar.

85. The computer program product of claim 72, wherein the organizational attribute is based upon an event.

86. The computer program product of claim 85, wherein the information management service comprises a calendar.

87. The computer program product of claim 72, wherein the organizational attribute is based upon a place.

88. The computer program product of claim 87, wherein the information management service comprises an address book.

89. The computer program product of claim 87, wherein the program code for associating is operable to chronologically order media objects related to the same place.

90. The computer program product of claim 72, wherein the organizational attribute is based upon a person.

91. The computer program product of claim 90, wherein the information management service comprises an address book.

92. The computer program product of claim 90, wherein the organizational attribute is based upon an identification of a calling number from a telephone.

93. The computer program product of claim 73, wherein the apparatus comprises a digital camera.

94. The computer program product of claim 73, wherein the apparatus comprises an audio device.

95. The computer program product of claim 73, wherein the apparatus comprises an email server.

96. The computer program product of claim 95, wherein the organizational attribute is based upon a sender of email, and the information management service comprises an address book.

97. The computer program product of claim 73, wherein the apparatus comprises a media server.

98. The computer program product of claim 73, wherein the apparatus comprises a GPS unit.
